(19) United States
(12) Patent Application Publication
(10) Pub. No.: US 2014/0044836 A1
(43) Pub. Date: Feb. 13, 2014

(54) METHODS FOR INCREASING THE PALATABILITY OF FOOD COMPOSITIONS

(71) Applicant: Glenn Earl Gibson, Crestwood, MO (US)

(72) Inventor: Glenn Earl Gibson, Crestwood, MO (US)

(73) Assignee: NESTEC SA, Vevey (CH)

(21) Appl. No.: 14/113,840

(22) PCT Filed: Apr. 20, 2012
(86) PCT No.: PCT/US12/34423

§ 371 Date: Oct. 25, 2013

Related U.S. Application Data
(60) Provisional application No. 61/518,083, filed on Apr. 29, 2011.

(51) Int. Cl. A23K 1/18

(52) U.S. Cl. CPC A23K 1/1853
USPC 426/72; 426/650; 426/302; 426/601; 426/643; 426/641; 426/623

(57) ABSTRACT

The invention provides food compositions and methods for increasing the palatability of food compositions. In one aspect, the methods comprise adding an egg and chicken flavoring to a food composition. Prior to being added to the food composition, the egg and chicken flavoring can be incorporated in or on any suitable carrier such as, for example, on a soybean, corn or wheat meal carrier. The egg and chicken flavoring has been found to increase the palatability of food compositions over corresponding conventional food compositions that do not include the egg and chicken flavoring.

### CROSS REFERENCE TO RELATED APPLICATIONS

This application claims priority to U.S. Provisional Application Ser. No. 61/518083 filed Apr. 29, 2011, the disclosure of which is incorporated herein by this reference.

### BACKGROUND OF THE INVENTION

1. Field of the Invention

The invention relates generally to methods for increasing the palatability of food compositions and particularly to using an egg and chicken flavoring for increasing the palatability of food compositions.

2. Description of Related Art

Improving animal acceptance of pet food compositions is a constant effort in the highly competitive pet food industry. With estimated U.S. retail sales approaching $18 billion, a small increase in market share is worth substantial money.

Dry and soft-dry pet food compositions comprise a major proportion of commercially available diets for pets. These are presented as small bite-sized pieces and are described variously as kibbles or pellets. These kibbles are produced by cooking and extruding through dies of varying shapes. The kibble sizes are generally proportioned to the size of an animal so that they can be consumed by the animal without causing any discomfort. The dry food product is typically less than 10% moisture, while soft-dry products are usually 10-16% moisture and require preservatives for shelf stability.

Dry and soft-dry pet food compositions are not as palatable as wet (e.g., high moisture and heat sterilized) pet foods. There are therefore continual efforts to increase the palatability of dry and soft-dry pet food compositions. Numerous ingredients including yeasts, fatty acids, plant extracts, and dry and liquid animal digests have been used to improve animal acceptance of pet food compositions. Most often, these ingredients are applied to the surface of the pet food compositions for maximum attraction and acceptance impact. In most cases, any improvement in animal acceptance has been relatively small within economical usage rates.

There is, therefore, a need for pet food compositions having increased palatability and methods of making such pet food compositions.

### SUMMARY OF THE INVENTION

It is, therefore, an object of the present invention to provide methods for increasing the palatability of food compositions.

It is another object of the invention to provide a pet food composition having increased palatability.

It is a further object of the invention to provide a food composition having an egg and chicken flavoring.

It is yet another object of the present invention to provide containers and packages including a pet food composition having increased palatability.

It is yet another object of the present invention to provide methods of manufacturing a food composition having an egg and chicken flavoring in a container or package.

One or more of these or other objects are achieved by adding an egg and chicken flavoring to a food composition. Prior to being added to the food composition, the egg and chicken flavoring can be on any suitable carrier such as, for example, on a soybean, corn or wheat meal carrier. The egg and chicken flavoring has been found to increase the palatability of food compositions over corresponding conventional food compositions that do not include the egg and chicken flavoring.

Other and further objects, features, and advantages of the present invention will be readily apparent to those skilled in the art.

### DETAILED DESCRIPTION OF THE INVENTION

### Definitions

The term “animal” means any animal that could benefit from an increase in palatability of food compositions, e.g., a human, avian, bovine, canine, equine, feline, hicrine, lupine, murine, ovine, and porcine animals.

The term “pet” means domesticated animals such as cats, dogs, rabbits, guinea pigs, ferrets, hamsters, mice, gerbils, horses, cows, goats, sheep, donkeys, pigs, and the like.

The term “egg and chicken flavoring” means the protein mixtures described and made using the process disclosed in U.S. Pat. No. 7,329,425. The egg and chicken flavoring can include an associated carrier as disclosed in U.S. Pat. No. 7,329,425.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual components physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “food composition” or “a method of making a food composition” includes a plurality of such “food compositions” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of” and “consisting of”. Similarly, the term “consisting essentially of” is intended to include embodiments encompassed by the term “consisting of”.

All percentages expressed herein are by weight of the total weight of the food composition unless expressed otherwise. For example, an egg and chicken flavoring in an amount of 25% by weight means that the amount of the egg and chicken flavoring is 25% of the total weight of the food composition. Thus, if the total weight of the food composition is 100 grams, the actual amount of the egg and chicken flavoring corresponding to 25% by weight would be 25 grams.

The methods and compositions and other advances disclosed here are not limited to particular methodology, protocols, ingredients, components and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides a method for increasing the palatability of food compositions. The method comprises adding an egg and chicken flavoring to a food composition. Prior to being added to the food composition, the egg and chicken flavoring can be incorporated in or on any suitable carrier such as, for example, on a soybean, corn or wheat meal carrier.

In the method, the food composition can be any suitable composition intended for human or animal consumption. In an embodiment of the method, the food composition is a pet food composition suitable for a pet, particularly a dog or cat. The base of the pet food composition can include any suitable cereal grains or starches, rendered or fresh animal and/or fish carcass or parts thereof, animal or fish fat/oil, flavors, colors, visible nutritional ingredients, vitamins and minerals typically associated with pet food compositions. The pet food composition can be in any suitable form such as, for example, an extruded pet food composition. The pet food composition can also be in a form such as kibbles, pellets, grains, baked products, dried products, or a combination thereof.

Preferably, the egg and chicken flavoring is added to the food composition in an amount ranging from about 2.5% to about 30% by weight. More preferably, the egg and chicken flavoring is added to the food composition in an amount ranging from about 3.5% to about 20% by weight. Most preferably, the egg and chicken flavoring is added to the food composition in an amount ranging from about 5% to about 10% by weight. In any of the embodiments described herein, the amount/weight of the egg and chicken flavoring can include the carrier as part of the amount/weight as well.

In an embodiment, the egg and chicken flavoring can be an equivalent substitute in the food composition for a component such as a dried egg product, frozen chicken, poultry by-product meal, corn gluten meal, or a combination thereof that typically make up a pet food composition. Replacing or substituting such components with the egg and chicken flavoring can improve the animal acceptance of the same or similar food or pet food compositions with an advantage of being incorporated into the food or pet food compositions while replacing a portion of existing raw materials that are components of the egg and chicken flavoring.

The egg and chicken flavoring can be added to the food composition in any suitable manner. In one embodiment, the egg and chicken flavoring is added by coating the food composition with the egg and chicken flavoring. In another embodiment, the egg and chicken flavoring is added to the food composition by mixing the egg and chicken flavoring with the food composition at some point when the food composition is manufactured or produced.

In another aspect, the invention provides a food composition having increased palatability. The food composition comprises one or more comestible ingredients and an egg and chicken flavoring. The food composition can be a pet food composition, particularly a dog or cat food composition. The base of the pet food composition can include any suitable cereal grains or starches, rendered or fresh animal and/or fish carcass or parts thereof, animal or fish fat/oil, flavors, colors, visible nutritional ingredients, vitamins and minerals typically associated with pet food compositions. The pet food composition can be in the form of an extruded pet food composition or a form such as kibbles, pellets, grains, baked products, dried products, or a combination thereof.

In another aspect, the invention provides a kit comprising in separate containers in a single package or in separate containers in a virtual package, as appropriate for a kit component, (A) a food composition comprising one or more comestible ingredients and an egg and chicken flavoring and (B) one or more of: (1) a description of the benefits of the food composition comprising the egg and chicken flavoring; (2) instructions for how to serve the food composition comprising the egg and chicken flavoring; (3) a packet containing an additional egg and chicken flavoring; (4) a second food composition; (5) a serving platter for serving the food composition comprising the egg and chicken flavoring; or (6) a serving utensil for serving the food composition comprising the egg and chicken flavoring.

When the kit comprises a virtual package, the kit can be limited to instructions in a virtual environment in combination with one or more physical kit components. The kits may contain the kit components in any of various combinations and/or mixtures. For example, in one embodiment, the kit includes a container having a food composition comprising an egg and chicken flavoring described herein and a packet containing an additional egg and chicken flavoring. In another embodiment, the kit includes a container having a food composition comprising an egg and chicken flavoring described herein and a serving platter.

In an alternative aspect, the invention provides a means for communicating information about or instructions for a food composition comprising one or more comestible ingredients and an egg and chicken flavoring for one or more of: (1) administering the food composition having the egg and chicken flavoring to an animal; (2) describing the benefits of the food composition comprising the egg and chicken flavoring; (3) instructing how to serve the food composition comprising the egg and chicken flavoring; or (4) promoting the health or wellness of an animal.

The communication means can be a document, digital storage media, optical storage media, audio presentation, or visual display containing the information or instructions. More specifically, the means can be a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, or any combination thereof.

In another aspect, the invention provides a package comprising indicia describing a food composition having increased palatability. The food composition comprises one or more comestible ingredients and an egg and chicken flavoring. The indicia can be in the form of words, symbols, pictures, photographs, figures, or combinations thereof to show details or examples of the food composition having increased palatability comprising the egg and chicken flavoring described herein. The package can further contain a food composition having increased palatability comprising an egg and chicken flavoring inside a container.

In an alternative aspect, the invention provides a method for manufacturing a container including a food composition having increased palatability. The method comprises providing one or more comestible ingredients, combining an egg and chicken flavoring with the comestible ingredients to produce a food composition having enhanced palatability, and filling the container with the food composition having increased palatability. The manufacturing method can further comprise retorting the container.

During manufacturing, the egg and chicken flavoring can be combined with the comestible ingredients by coating the comestible ingredients with the egg and chicken flavoring. Alternatively, or in addition to, the egg and chicken flavoring can be combined with the comestible ingredients by mixing the egg and chicken flavoring with the comestible ingredients at any point during the manufacturing process. The manufactured food composition can be a pet food composition made by suitable pet food manufacturing processes. In preferred embodiments, the food composition is formulated for a dog or for a cat. In an embodiment, the food composition is a pet food kibble that has been coated with egg and chicken flavoring. In another, the food composition is a pet food kibble that has egg and chicken flavoring within the kibble, either uniformly or non-uniformly.

In another aspect, the invention provides continuous production lines capable of manufacturing a container comprising a food composition having one or more comestible ingredients and an egg and chicken flavoring. More specifically, the continuous production lines can include various devices for making a container having the food composition. For example, the continuous production lines can include a mechanical mixer for combining the comestible ingredients and the egg and chicken flavoring. The continuous production lines can include an extruder for extruding the food composition. The extruded food composition having the egg and chicken flavoring can be cut into kibbles or pellets and filled in a container. The filled container can then be sealed or closed and taken to a steamer/retorting station. A conveyor belt can be used to transport the containers from one station to another station of the continuous production lines.

In an alternative aspect, the invention provides multi-pack packages comprising 1) a plurality of containers arranged in an array, each of the plurality of containers comprising a food composition having an egg and chicken flavoring described herein, and 2) one or more devices for retaining the containers in the array. In various embodiments, the devices are boxes made from paper, plastic, polymers, or a combination thereof. In others, the devices are systems of connected plastic rings affixed to each of the containers. In still others, the devices are wrappings of plastic of similar materials, e.g., twelve cans stacked in an array and wrapped in plastic. In some embodiments, the multi-pack packages have one or more handles affixed to the multi-pack packages to facilitate handling and transporting the multi-pack packages.

In other embodiments, the devices further comprise one or more windows that permit the package contents to be viewed without opening the multi-pack package. In some embodiments, the windows are a transparent portion of the devices. In others, the windows are missing portions of the devices that permit the containers to be viewed without opening the multi-pack package.

In preferred embodiments, the multi-pack packages further comprise one or more indicia describing the contents of the containers in the packages. The indicia can be in the form of labels, printing on the packages, stickers, and the like and include words, symbols, pictures, photographs, figures, or combinations thereof to provide detail or examples of the improved palatability of the food composition having the egg and chicken flavoring described herein. In a preferred embodiment, a label is affixed to the multi-pack packages containing a word or words, picture, design, acronym, slogan, phrase, or other device, or combination thereof, that indicates that the contents of the package contain a pet food composition having improved palatability over convention pet food compositions.

### EXAMPLES

The invention can be further illustrated by the following examples, although it will be understood that these examples are included merely for purposes of illustration and are not intended to limit the scope of the invention unless otherwise specifically indicated.

### Example 1

Trials were conducted with a super premium dog food composition at 5%, 7.5%, and 10% inclusion levels of an egg and chicken flavoring on a corn gluten meal carrier, replacing portions of the flavor's components existing in the control formula one for one. As seen in Table 1, the test and control formulas were similar.

TABLE 1

| | Moisture | Protein | Fat |
|---|---|---|---|
| Control | 9.16 | 26.1 | 16.2 |
| 5% E&C | 9.06 | 26.7 | 16.9 |
| 7.5% E&C | 9.38 | 25.9 | 16.3 |
| 10% E&C | 9.14 | 26.5 | 16.7 |

Standard palatability trials conducted in a round robin format showed animal preference of 4:1 in favor of the test formulas at each inclusion rate compared to the standard control formula. Repeating this trial with a different lot of egg and chicken flavoring on corn gluten meal carrier duplicated these results. These results are shown in Table 2.

Later trials in a premium dog food composition at 2.5% and 5% inclusion rates showed similar improvements in animal acceptance compared to the standard control formula (Table 2). Animal preference of the rations containing the egg and chicken flavoring on corn gluten meal carrier at 2.5% and 5% inclusion levels averaged 3:1 over a series of feeding trials.

TABLE 2

| | % Consumption | |
|---|---|---|
| | Control | E&C |
| Control vs. 5% | 13 | 87 |
| Control vs. 7.5% | 15 | 85 |
| Control vs. 10% | 13 | 87 |
| Control vs. 2.5% | 31 | 69 |
| Control vs. 5% | 27 | 73 |

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A method for increasing the palatability of a food composition comprising adding an egg and chicken flavoring to the food composition.

2. The method of claim 1 wherein the egg and chicken flavoring is added to the food composition in an amount ranging from about 2.5% to about 30% by weight.

3. The method of claim 1 wherein the egg and chicken flavoring is added to the food composition in an amount ranging from about 3.5% to about 20% by weight.

4. The method of claim 1 wherein the egg and chicken flavoring is added to the food composition in an amount ranging from about 5% to about 10% by weight.

5. The method of claim 1 wherein the egg and chicken flavoring is added to the food composition by coating the food composition with the egg and chicken flavoring.

6. The method of claim 1 wherein the egg and chicken flavoring is added to the food composition by mixing the egg and chicken flavoring with the food composition.

7. The method of claim 1 wherein the egg and chicken flavoring is an equivalent substitute in the food composition for a component selected from the group consisting of a dried egg product, frozen chicken, poultry by-product meal, corn gluten meal, and combinations thereof.

8. The method of claim 1 wherein the food composition is a pet food composition.

9. The method of claim 8 wherein the pet food composition is an extruded pet food composition.

10. The method of claim 8 wherein the pet food composition is a form selected from the group consisting of kibbles, pellets, grains, baked products, dried products, and combinations thereof.

11. The method of claim 1 wherein food composition further includes one or more edible ingredients selected from the group consisting of cereal grains, starches, rendered or fresh animal or fish carcasses or parts thereof, animal or fish fat/oil, flavors, colors, visible nutritional ingredients, vitamins, minerals, and combinations thereof.

12. A food composition having increased palatability comprising one or more comestible ingredients and an egg and chicken flavoring.

13. The food composition of claim 12 wherein the food composition is a pet food composition.

14. The food composition of claim 13 wherein the pet food composition is an extruded pet food composition.

15. The food composition of claim 13 wherein the pet food composition is a form selected from the group consisting of kibbles, pellets, grains, baked products, dried products, and combinations thereof.

16. The food composition of claim 12 wherein the food composition includes one or more edible ingredients selected from the group consisting of cereal grains, starches, rendered or fresh animal or fish carcasses or parts thereof, animal or fish fat/oil, flavors, colors, visible nutritional ingredients, vitamins, minerals, and combinations thereof.

17. (canceled)

18. (canceled)

19. (canceled)

20. (canceled)

21. (canceled)

22. A method for manufacturing a container including a food composition having increased palatability comprising providing one or more comestible ingredients, combining an egg and chicken flavoring with the comestible ingredients to produce a food composition having enhanced palatability, and filling the container with the food composition having increased palatability.

23. The method of claim 22 further comprising retorting the container.

24. The method of claim 22 wherein the egg and chicken flavoring is combined with the comestible ingredients by mixing the egg and chicken flavoring with the comestible ingredients.

25. The method of claim 22 wherein the food composition is a pet food composition.

26. (canceled)

27. (canceled)

28. (canceled)

29. (canceled)

30. (canceled)

31. (canceled)

32. (canceled)

33. (canceled)

34. The method of claim 8 wherein the pet food composition is a kibble.

35. The food composition of claim 13 wherein the pet food composition is a kibble.
